(19) United States
(12) Patent Application Publication
(10) Pub. No.: US 2024/0097323 A1
(43) Pub. Date: Mar. 21, 2024

(54) DIRECTIONAL RADIATION CONTROL DEVICES

(71) Applicant: Hewlett-Packard Development Company, L.P., Spring, TX (US)

(72) Inventors: Chin-Hung Ma, Taipei City (TW); Pai-Cheng Huang, Taipei City (TW); Po Chao Chen, Taipei (TW); Shih-Huang Wu, Spring, TX (US)

(21) Appl. No.: 17/945,305

(22) Filed: Sep. 15, 2022

(51) Int. Cl. H01Q 3/14

(52) U.S. Cl. CPC H01Q 3/14

(57) ABSTRACT

In some examples, a device can include an antenna to emit waves in a radiation pattern having a first beamwidth, a directional radiation control device located in a path of the waves, where the directional radiation control device is to receive the waves from the antenna and is shaped to cause the waves to be directed in a different radiation pattern having a second beamwidth that is larger than the first beamwidth.

### BACKGROUND

Users of computing devices may utilize their computing devices for various purposes. A computing device can allow a user to utilize computing device operations for work, education, gaming, multimedia, and/or other general use. Certain computing devices can be portable to allow a user to carry or otherwise bring with the computing device while in a mobile setting, while other computing devices may not be portable but allow a user to utilize the computing device in an office or home setting.

### BRIEF DESCRIPTION OF THE DRAWINGS

FIG. 1 is a side view of an example of a device including an antenna and a directional radiation control device consistent with the disclosure.

FIG. 2 is a perspective view of an example of a directional radiation control device consistent with the disclosure.

FIG. 3 is a side view of an example of a device including an antenna and a directional radiation control device causing waves to be directed in different radiation patterns consistent with the disclosure.

FIG. 4A is a side view of an example of a computing device including an antenna, a directional radiation control device in a first position, a motor, and a controller to rotate the directional radiation control device consistent with the disclosure.

FIG. 4B is a side view of an example of a computing device including an antenna, a directional radiation control device in a second position, a motor, and a controller to rotate the directional radiation control device consistent with the disclosure.

FIG. 5 is a perspective view of an example of a computing device having antennae and directional radiation control devices consistent with the disclosure.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AlO) computer (e.g., a computing device in which computing hardware and a display device are included in a single housing), a mobile device, among other types of computing devices.

Certain computing devices can utilize an antenna for wireless communication with other devices. As used herein, the term “antenna” refers to a device that converts radio waves into an electrical signal or vice-versa. For example, the antenna of the computing device can receive and/or transmit information (e.g., via radio waves) to a different computing device in order to communicate with the different computing device or any other device capable of wireless communication.

For certain communication types, a particular type and/or amount of antennas can be utilized that can provide a user of the computing device with a positive user experience. For example, the particular type and/or the amount of antennas can be chosen in order to allow for the computing device to wirelessly communicate with other devices seamlessly to minimize communication wait time to send and/or receive information to and/or from other devices.

An antenna used for wireless communication can, in some instances, be a directional antenna. As used herein, the term “directional antenna” refers to an antenna which radiates or receives power in specific directions. For example, a directional antenna can radiate power in a particular radiation pattern, sending waves in the particular radiation pattern. As used herein, the term “radiation pattern” refers to a directional dependence of strength of radio waves emitted from an antenna. For instance, the directional antenna can radiate waves in a particular radiation pattern in order to minimize communication wait time to send and/or receive information with another device.

The particular radiation pattern can have an associated antenna beamwidth. As used herein, the term “beamwidth” refers to an angle from which a majority of an antennas power radiates. The antenna beamwidth can determine an expected signal strength given a radiation pattern and radiation distance of an antenna.

While the particular type and/or amount of antennas can be chosen in order to allow for the computing device to wirelessly communicate with other devices seamlessly, power consumption in computing devices by such antennas may be higher, which can result in a shortened battery life for the computing device. Additionally, certain computing devices are being designed with a smaller form factor. In such approaches, it can be difficult to include the particular amount of antennas within such a smaller form factor due to space constraints of the smaller form factor.

Directional radiation control devices according to the disclosure can allow for radio waves emitted by an antenna in a particular radiation pattern to be directed in another radiation pattern. The redirected radiation pattern can increase the beamwidth. Such an approach can increase antenna performance as a result of increasing the beamwidth, allowing for better beamforming coverage as compared with previous approaches. Additionally, the increased beamwidth can allow for the amount of antennas included in a computing device to be reduced while still providing sufficient performance, reducing costs as compared with previous approaches.

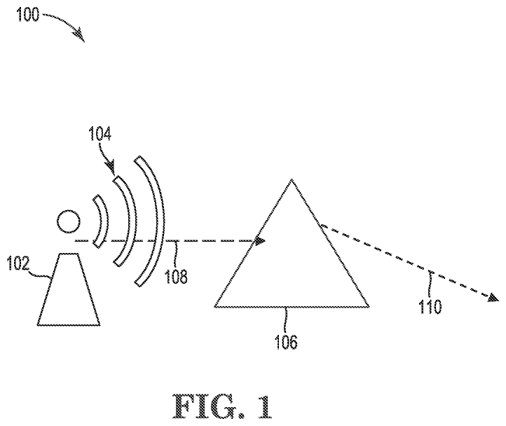

FIG. 1 is a side view of an example of a device 100 including an antenna 102 and a directional radiation control device 106 consistent with the disclosure. As illustrated in FIG. 1, the antenna 102 emits waves 104 in a radiation pattern 108.

As illustrated in FIG. 1, the device 100 includes an antenna 102. As mentioned above, the antenna 102 can radiate power/emit waves 104 in a particular direction. The direction can be a radiation pattern 108. For example, the antenna 102 can emit waves 104 with a directional dependence of strength in the direction (e.g., the radiation pattern 108) towards a directional radiation control device 106, as is further described herein.

In some examples, the antenna 102 can be a millimeter (mm) wave (mmWave) antenna. As used herein, the term “mmWave antenna” refers to an antenna that utilizes the 30 to 300 Gigahertz (GHz) frequency band or the 1 centimeter (cm) to 1 mm wavelength range for communication. For instance, the antenna 102 can emit waves in the 30 to 300 GHz frequency band for communication with other devices. Utilizing the mmWave antenna (e.g., and the associated frequency band/wavelength range) can allow for resolution of spectrum crowding issues while permitting communication at high data rates. Additionally, the short wavelengths can allow for the antenna 102 to have high directivity while being compact in size. Accordingly, such an antenna 102 may be utilized in devices where space considerations may be a design factor.

In some examples, the device 100 may include mobile device communication capabilities. For example, the device 100 may communicate with other computing devices via a mobile/cellular communications network. Such a network may include a 5G network, among other types of cellular communication networks. In some examples, the mmWave antenna can be utilized for communication on such networks.

As mentioned above, the waves 104 can be electromagnetic radio waves. As used herein, the term “electromagnetic radio waves” refers to a type of electromagnetic radiation having wavelengths between 30 to 300 GHz. For example, the waves 104 emitted by the antenna 102 can be in the 30 to 300 GHz frequency band.

The radiation pattern 108 associated with the emitted waves 104 can have a first beamwidth. As used herein, the term “beamwidth” refers to an angle from which a majority of an antenna's power radiates. In other words, the beamwidth is the area where most of the power is radiated. For example, the waves 104 emitted by the antenna 102 can have a first beamwidth of 90°. Since the beamwidth can determine an expected signal strength (e.g., given a direction and radiation distance of the antenna 102), the first beamwidth of the radiation pattern 108 can be associated with a particular signal strength.

While the device 100 is attempting to/in communication with another device (e.g., not illustrated in FIG. 1), a signal strength with the other device may be lower than desired. The waves 104 can be directed, using the directional radiation control device 106, in a different radiation pattern having a larger beamwidth than the first beamwidth of the radiation pattern 108 to provide better antenna performance, as is further described herein.

As illustrated in FIG. 1, the device 100 includes a directional radiation control device 106. As used herein, the term “directional radiation control device” refers to a device that is shaped to cause waves traveling through one side of the device in a first direction to be redirected a second direction traveling through another side of the device. For example, the directional radiation control device 106 can cause the waves 104 to be directed in a different radiation pattern 110 that is different from the radiation pattern 108, as is further described herein.

The directional radiation control device 106 can be located in a path of the emitted waves 104. For example, the antenna 102 can emit the waves 104 in the radiation pattern 108 and the directional radiation control device 106 can be located in the device 100 in the path of the waves 104 such that the waves 104 can be received from the antenna 102.

The directional radiation control device 106 can be shaped to have a cross-section having differing thicknesses. For example, as illustrated in FIG. 1, the directional radiation control device 106 can be shaped having a triangular cross-section. Accordingly, the directional radiation control device 106 can be a triangular prism.

While the directional radiation control device 106 is illustrated in FIG. 1 as being an isosceles triangular prism, examples of the disclosure are not so limited. For example, the directional radiation control device 106 can be an equilateral, right, scalene, acute, or obtuse triangular prism, among other examples.

Additionally, while the directional radiation control device 106 is described herein as being a triangular prism, examples of the disclosure are not so limited. For example, the directional radiation control device 106 can be any other shape having a cross-section with differing thicknesses so that waves 104 are directed from the radiation pattern 108 to a different radiation pattern 110, as is further described herein.

The directional radiation control device 106 can be of a dielectric material. For example, the directional radiation control device 106 can be a material that transmits electric force without conduction. In other words, the directional radiation control device 106 can be made of a material so that the directional radiation control device 106 acts as an insulator. The directional radiation control device 106 can be, for example, glass, plastic, etc, so that waves 104 pass through the directional radiation control device 106 at the first radiation pattern 108 but change angle to the second radiation pattern 110.

As mentioned above, the directional radiation control device 106 can be in the path of the emitted waves 104 in order to receive the waves 104 from the antenna. The directional radiation control device 106 can receive the waves 104 in the first radiation pattern 108, and can be shaped to cause the waves 104 to be directed in the second radiation pattern 110. For example, the directional radiation control device 106, being made of a dielectric material having a cross-section with differing thicknesses can cause refraction of the waves 104 such that the waves 104 are directed in the second radiation pattern 110. As used herein, the term “refraction” refers to a phenomenon of waves being deflected when passing through a medium. That is, the directional radiation control device 106 causes the waves 104, received at a first surface (e.g., a left side surface of the triangular shape of the directional radiation control device 106 as illustrated in FIG. 1) in the first radiation pattern 108, to be refracted (e.g., deflected) as the waves travel through the directional radiation control device 106 and out (e.g., not illustrated in FIG. 1) from a second surface (e.g., a right side surface of the triangular shape of the directional radiation control device 106 as illustrated in FIG. 1) in the second radiation pattern 110.

The second radiation pattern 110 can have a second beamwidth. The second beamwidth of the second radiation pattern 110 can be larger than the first beamwidth of the first radiation pattern 108. For example, the refracted waves from the directional radiation control device 106 can have a second beamwidth of 130°, which is larger than the first beamwidth of 90°. The second beamwidth can be associated with a signal strength with another device that is greater than a signal strength with the another device associated with the first beamwidth. Accordingly, refracting the emitted waves 104 via the directional radiation control device 106 can improve the performance of the antenna 102.

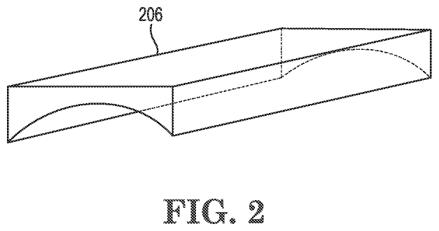

FIG. 2 is a perspective view of an example of a directional radiation control device 206 consistent with the disclosure. The directional radiation control device 206 can be, for example, utilized to cause refraction of waves (e.g., similar to the directional radiation control device 106, previously described in connection with FIG. 1), as is further described herein.

As illustrated in FIG. 2, the directional radiation control device 206 can be a prism having one side with a concave shape. The prism having the concave shape can include a cross-section having differing thicknesses.

Similar to the triangular prism previously described in connection with FIG. 1, the prism having the concave shape can be located in a path of emitted waves from an antenna. For example, waves emitted by the antenna in a first radiation pattern can be received by the concave shaped side of the directional radiation control device 206, the first radiation pattern having an associated first beamwidth. The concave shape of the directional radiation control device 206 can cause the waves in the first radiation pattern to be refracted in a second radiation pattern as the waves travel through the directional radiation control device 206, where the second radiation pattern has an associated second beamwidth that is larger than the first beamwidth.

While the directional radiation control device 206 is described as being a prism having one side with a concave shape (e.g., and the directional radiation control device 106, previously described in connection 1, is described as being a triangular prism), examples of the disclosure are not so limited. For example, the directional radiation control device 206 can have any other shape having a cross-section having differing thicknesses.

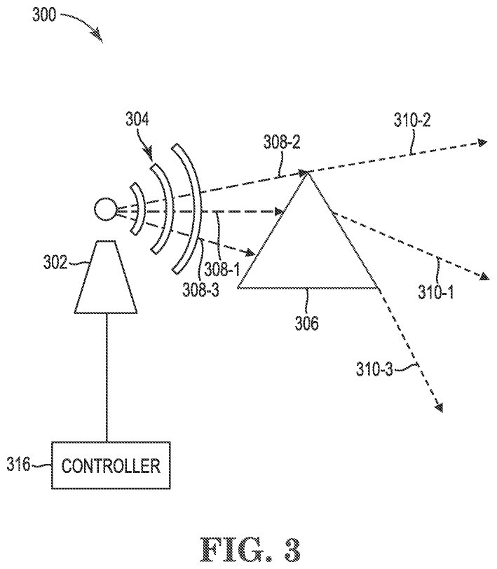

FIG. 3 is a side view of an example of a device 300 including an antenna 302 and a directional radiation control device 306 causing waves 304 to be directed in different radiation patterns consistent with the disclosure. As illustrated in FIG. 3, the antenna 302 emits waves 304 in various radiation patterns 308.

Similar to the device 100 previously described in connection with FIG. 1, the device 300 can include an antenna 302 and a directional radiation control device 306. The device 300 can further include a controller 316 having a processor and instructions stored in memory. The antenna 302 can be connected to the controller 316.

The processor can be, for example, a central processing unit (CPU), microprocessor, and/or other hardware device suitable for retrieval and execution of instructions stored in a non-transitory machine-readable storage medium (e.g., memory). As an alternative or in addition to retrieving and executing instructions, the processor may include an electronic circuit comprising a number of electronic components for performing the operations of the instructions in the non-transitory machine-readable storage medium.

The memory can be, for example, the non-transitory machine-readable storage medium. The non-transitory machine-readable storage medium may be any electronic, magnetic, optical, or other physical storage device that stores executable instructions. Thus, the non-transitory machine-readable storage medium may be, for example, Random Access Memory (RAM), an Electrically-Erasable Programmable Read-Only Memory (EEPROM), a storage drive, an optical disc, and the like.

The controller 316 (e.g., via the processor and instructions stored in the memory) can cause the antenna 302 to beamform waves 304 in a first radiation pattern 308-1 having a first beamwidth. As used herein, the term “beamform” refers to directional signal transmission or reception. For example, the controller 316 can cause the antenna 302 to beamform waves 304 in various radiation patterns, as is further described herein.

The directional radiation control device 306 can be located in a path of the beamformed waves 304 having the first radiation pattern 308-1, where the first radiation pattern 308-1 has an associated first beamwidth. The directional radiation control device 306 can receive the waves 304 from the antenna 302. The shape of the directional radiation control device 306 (e.g., having the cross-section with differing thicknesses) can cause the waves 304 in the first radiation pattern 308-1 to be refracted in a second radiation pattern 310-1 as the waves travel through the directional radiation control device 306, where the second radiation pattern 310-1 has an associated second beamwidth that is larger than the first beamwidth.

As such, the device 300 can operate similarly to the device 100, previously described in connection with FIG. 1. However, in some examples, antenna performance may be further improved by beamforming the waves 304 in a different direction by the antenna 302 (e.g., prior to being refracted by the directional radiation control device 306). Accordingly, the controller 316 can cause the antenna 302 to beamform the waves 304 in a different direction, as is further described herein.

The controller 316 can cause the antenna 302 to beamformed waves 304 in a second radiation pattern 308-2 having the first beamwidth. Similarly, the directional radiation control device 306 can be located in a path of the beamformed waves 304 having the second radiation pattern 308-2. The directional radiation control device 306 can receive the waves 304 from the antenna 302. The shape of the directional radiation control device 306 (e.g., having the cross-section with differing thicknesses) can cause the waves 304 in the second radiation pattern 308-2 to be refracted in a further radiation pattern 310-2 as the waves travel through the directional radiation control device 306, where the further radiation pattern 310-2 has an associated third beamwidth that is larger than the first beamwidth. Additionally, the third beamwidth can be larger than the second beamwidth.

Additionally, in some examples, the controller 316 may cause the antenna 302 to beamform waves 304 in a third radiation pattern 308-3 having the first beamwidth. The directional radiation control device 306 can cause the waves 304 in the third radiation pattern 308-3 to be refracted in another radiation pattern 310-3 having a beamwidth that is different from the first, second, and third beamwidth.

The beamwidth of radiation pattern 310-3 can be the largest beamwidth, and the beamwidth of radiation pattern 310-2 can be the smallest beamwidth, where the beamwidth of radiation pattern 310-1 can be between the beamwidth of radiation patterns 310-3 and 310-2. In other words, the controller 316 can determine which beamwidth would be the ideal beamwidth to use for a given communication situation, as is further described herein.

The controller 316 can determine which beamwidth is ideal based on gain. As used herein, the term “gain” refers to a measure of how strong a signal an antenna can send or receive in a specified direction. For example, the controller 316 can determine the gain of the antenna 302 when the antenna is beamforming the waves 304 in the radiation pattern 308-1 (e.g., and the waves being refracted in the radiation pattern 310-1). In response to the gain being below a threshold amount (e.g., of gain), the controller 316 can cause the antenna 302 to beamform the waves 304 in another radiation pattern 308 (e.g., 308-2). Accordingly, the controller 316 can cause the antenna 302 to beamform waves 304 in a particular direction according to the performance of the antenna 302.

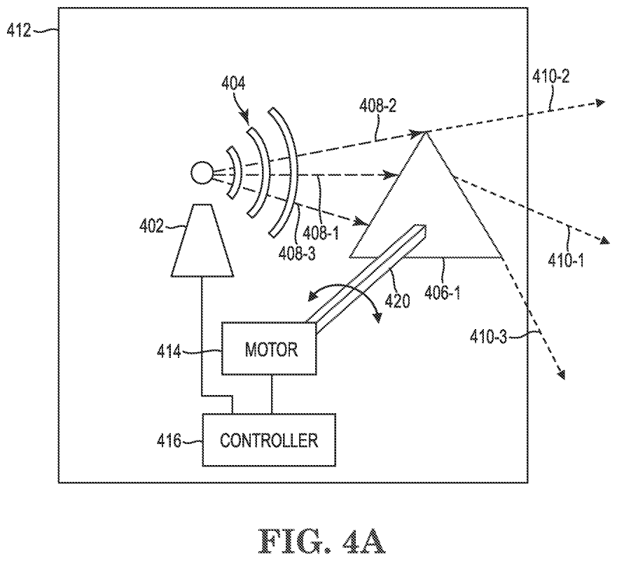

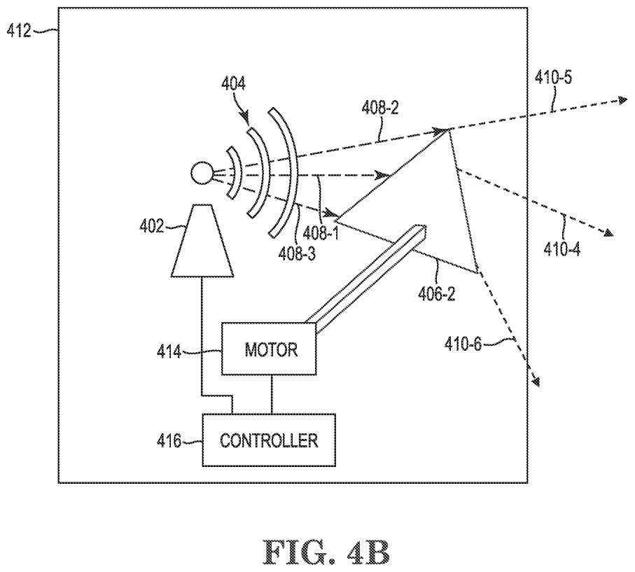

FIG. 4A is a side view of an example of a computing device 412 including an antenna 402, a directional radiation control device 406-1 in a first position, a motor 414, and a controller 416 to rotate the directional radiation control device 406-1 consistent with the disclosure. As illustrated in FIG. 4, the directional radiation control device 406-1 is in the first position.

Similar to the device 100 previously described in connection with FIG. 1, the computing device 412 can include an antenna 402 and a directional radiation control device 406. The computing device 412 can further include a controller 416 having a processor and memory. The antenna 402 can be connected to the controller 416.

The controller 416 can cause the antenna 402 to beamform waves 404 in a first radiation pattern 408-1 having a first beamwidth. As used herein, the term “beamform” refers to directional signal transmission or reception. For example, the controller 416 can cause the antenna 402 to beamform waves 404 in various radiation patterns.

The directional radiation control device 406 can be located in a path of the beamformed waves 404 having the first radiation pattern 408-1, where the first radiation pattern 408-1 has an associated first beamwidth. The directional radiation control device 406 can receive the waves 404 from the antenna 402. The shape of the directional radiation control device 406 (e.g., having the cross-section with differing thicknesses) can cause the waves 404 in the first radiation pattern 408-1 to be refracted in a second radiation pattern 410-1 as the waves travel through the directional radiation control device 406, where the second radiation pattern 410-1 has an associated second beamwidth that is larger than the first beamwidth.

As such, the antenna 402 and the directional radiation control device 406-1 can operate similarly to the device 100 previously described in connection with FIG. 1. Additionally, antenna performance may be further improved by beamforming the waves 404 in a different directions by the antenna 402 (e.g., prior to being refracted by the directional radiation control device 306), and as such, the antenna 402 and the directional radiation control device 406-1 can operate similarly to the device 300 previously described in connection with FIG. 1.

As illustrated in FIG. 4A, the motor 414 can be connected to the directional radiation control device 406-1 via a connecting arm 420. As used herein, the term “connecting arm” refers to a member connected to a first device and a second device. In some examples, the controller 416 can cause the directional radiation control device 406-1 to be rotated (e.g., via the motor 414) to further allow for the directional radiation control device 406-1 to direct the beamformed waves 404 in further different radiation patterns, as is further described herein.

As previously described in connection with FIG. 3, the directional radiation control device 406-1 can cause the beamformed waves 404 to be refracted in various radiation patterns 410-1, 410-2, 410-3. However, in some examples, the directional radiation control device 406-1 can be rotated to allow for different radiation patterns. In such an example, the controller 416 can determine a gain of the antenna 402 while the directional radiation control device 406-1 is in the first position (e.g., as illustrated in FIG. 4A).

In response to the gain of the antenna 402 being less than a threshold gain amount, the controller can cause the directional radiation control device 406-1 to rotate from the first position to a second position. As illustrated in FIG. 4A, the computing device 412 further includes a motor 414 connected to the directional radiation control device 406-1. As used herein, the term “motor” refers to a device that supplies mechanical energy to another device. For example, the controller 416 can cause the motor 414 to rotate the connecting arm 420, which causes the directional radiation control device 406-1 to rotate from the first position (e.g., as illustrated in FIG. 4A) to a second position (e.g., as is further described in connection with FIG. 4B). That is, the controller 416 can cause the directional radiation control device 406-1 to rotate from the first position to the second position using the motor 414,

FIG. 4B is a side view of an example of a computing device 412 including an antenna 402, a directional radiation control device 406-2 in a second position, a motor 414, and a controller 416 to rotate the directional radiation control device 406-2 consistent with the disclosure. As illustrated in FIG. 4, the directional radiation control device 406-1 is in the second position.

As illustrated in FIG. 4B, the directional radiation control device 406-2 is oriented at a slightly different angle in the second position than in the first position, but while still being located in a path of the beamformed waves 404, Accordingly, while the antenna 402 can beamform waves 404 in the various radiation patterns 408-1, 408-2, 408-3, the directional radiation control device 406-2 can cause the beamformed waves 404 to be refracted in various radiation patterns 410-4, 410-5, 410-6, which are different from the radiation patterns 410-1, 410-2, 410-3, previously described in connection with FIG. 4A when the directional radiation control device 406-2 is in the first position.

Accordingly, the directional radiation control device 406-2 can receive the waves 404 from the antenna 402 in the various radiation patterns 408-1, 408-2, or 408-3. The shape of the directional radiation control device 406-2 (e.g., having the cross-section with differing thicknesses) can cause the waves 404 in the radiation patterns 408-1, 408-2, or 408-3 to be refracted in radiation patterns 410-4, 410-5, or 410-6, respectively, as the waves travel through the directional radiation control device 406-2 while the directional radiation control device 406-2 is in the second position, where the radiation patterns 410-4, 410-5, or 410-6 have associated beamwidths that are different from the beamwidths of the radiation patterns 410-1, 410-2, or 410-3.

Although not illustrated in FIGS. 4A and 4B, the computing device 412 can include an additional radiation control device controlled by the motor 414 or by an additional motor. The additional directional radiation control device can also be located in a path of the beamformed waves 404 having the first radiation pattern 408-1, where the first radiation pattern 408-1 has an associated first beamwidth. The additional directional radiation control device can receive the waves 404 from the antenna. The shape of the additional directional radiation control device (e.g., having the cross-section with differing thicknesses) can be the same shape as the directional radiation control device 406-1, a mirrored shape of the directional radiation control device 406-1, etc. The additional directional radiation control device can cause the waves in the first radiation pattern to be refracted in a second radiation pattern as the waves travel through the additional directional radiation control device, where the second radiation pattern has an associated second beamwidth that is larger than the first beamwidth. Additionally, the additional directional radiation control device can be rotated (e.g., similar to the directional radiation control device 406-1/406-2, as described above) by the motor 414 or by the additional motor (e.g., not illustrated in FIG. 4A or 4B).

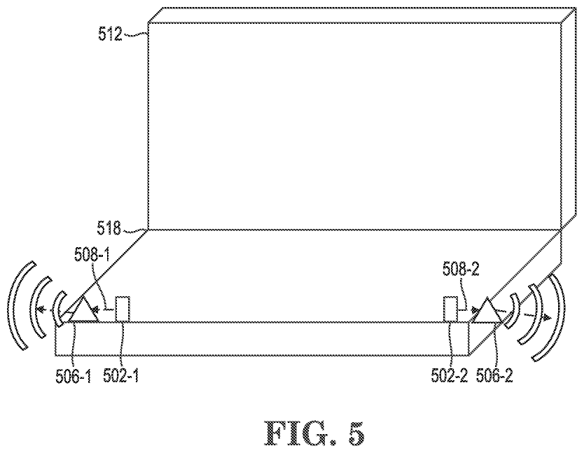

FIG. 5 is a perspective view of an example of a computing device 512 having antennae 502-1, 502-2 and directional radiation control devices 506-1, 506-2, consistent with the disclosure. As illustrated in FIG. 5, the computing device 512 can include a housing 518 having the antennae 502-1, 502-2 and the directional radiation control devices 506-1, 506-2 disposed therein.

For example, the housing 518 can include antenna 502-1 to beamform electromagnetic waves in a first radiation pattern having a first beamwidth, and a directional radiation control device 506-1 disposed in the housing 518 proximate to the antenna 502-1 and located in a path of the electromagnetic waves emitted from the antenna 502-1. The directional radiation control device 506-1 can receive the electromagnetic waves from the antenna 502-1 and be shaped to cause the electromagnetic waves from the antenna 502-1 to be refracted in a second radiation pattern having a second beamwidth in order to improve the performance of the antenna 502-1.

Similarly, the housing 518 can include antenna 502-2 to beamform electromagnetic waves in a first radiation pattern having a first beamwidth, and a directional radiation control device 506-2 disposed in the housing 518 proximate to the antenna 502-2 and located in a path of the electromagnetic waves emitted from the antenna 502-2. The directional radiation control device 506-2 can similarly cause the electromagnetic waves from the antenna 502-2 to be refracted to improve the performance of the antenna 502-2.

As illustrated in FIG. 5, the computing device 512 can include multiple antennae 502-1, 502-2. Utilizing the directional control devices 506-1, 506-2, respectively, the beamwidths of the antennae 502-1, 502-2 emitting waves in radiation patterns 508-1, 508-2, respectively, can be modified to allow for increased performance utilizing the techniques as described above.

While the antennae 502-1, 502-2 and directional radiation control devices 506-1, 506-2 are illustrated as being in the particular periphery locations in the computing device 512 in FIG. 5, examples of the disclosure are not so limited. For example, the antennae 502-1, 502-2 and directional radiation control devices 506-1, 506-2 can be located in other parts of the housing 518 of the computing device 512.

Such an approach utilizing directional radiation control devices 506-1, 506-2 can allow for increased beamforming coverage as compared with previous approaches. Additionally, in some examples the increased beamwidth utilizing the antennae 502-1, 502-2 and directional radiation control devices 506-1, 506-2 can allow for the use of less antennae (e.g., two instead of three, as illustrated in FIG. 5) as compared with previous approaches while still providing sufficient antennae (e.g., and wireless communication) performance, reducing costs as compared with previous approaches.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

1. A device, comprising:
a housing;
an antenna disposed in the housing, to emit waves in a radiation pattern having a first beamwidth; and
a directional radiation control device disposed in the housing and separate from the antenna, located in a path of the waves, wherein the directional radiation control device is:
to receive the waves from the antenna; and
shaped to cause the waves to be directed in a different radiation pattern having a second beamwidth that is larger than the first beamwidth.

2. The device of claim 1, wherein the directional radiation control device causes refraction of the waves in the different radiation pattern.

3. The device of claim 1, wherein the directional radiation control device is shaped to have a cross-section having differing thicknesses.

4. The device of claim 1, wherein the antenna is a millimeter wave (mmWave) antenna.

5. The device of claim 1, wherein the waves are electromagnetic radio waves.

6. The device of claim 1, wherein the directional radiation control device is of a dielectric material.

7. The device of claim 1, wherein the directional radiation control device is shaped as a triangular prism.

8. The device of claim 1, wherein the directional radiation control device is shaped as prism having a side with a concave shape.

9. The device of claim 8, wherein the side with the concave shape is to receive the waves from the antenna.

10. A device, comprising:
a housing;
an antenna disposed in the housing;
a controller to cause the antenna to beamform waves in a first radiation pattern having a first beamwidth; and
a directional radiation control device disposed in the housing and separate from the antenna, located in a path of the waves, wherein the directional radiation control device is:
to receive the waves from the antenna; and
shaped to cause the waves to be directed in a different radiation pattern having a second beamwidth that is larger than the first beamwidth.

11. The device of claim 10, wherein the controller is to cause the antenna to beamform waves in a second radiation pattern having the first beamwidth, wherein the second radiation pattern is different from the first radiation pattern.

12. The device of claim 11, wherein the directional radiation control device is shaped to cause the waves to be directed in a further different radiation pattern from the different radiation pattern.

13. The device of claim 12, wherein the further different radiation pattern has a third beamwidth that is different from the first beamwidth and the second beamwidth.

14. A computing device, comprising:
a housing;
an antenna disposed in the housing to beamform electromagnetic radio waves in a first radiation pattern having a first beamwidth;
a directional radiation control device disposed in the housing proximate to the antenna and located in a path of the electromagnetic radio waves, wherein the directional radiation control device is:
to receive the electromagnetic radio waves from the antenna while oriented in a first position; and
shaped to cause the electromagnetic radio waves to be refracted in a second radiation pattern having a second beamwidth; and
a controller to cause the directional radiation control device to rotate from the first position to a second position;
wherein the directional radiation control device is:
to receive the electromagnetic radio waves from the antenna while oriented in the second position; and
shaped to cause the electromagnetic radio waves to be refracted in a third radiation pattern having a third beamwidth.

15. The computing device of claim 14, wherein the controller is to determine a gain of the antenna while the directional radiation control device is in the first position.

16. The computing device of claim 15, wherein in response to the gain being less than a threshold gain amount, the controller is to cause the directional radiation control device to rotate from the first position to the second position.

17. The computing device of claim 16, wherein the computing device includes a motor connected to the directional radiation control device.

18. The computing device of claim 17, wherein the motor is connected to the directional radiation control device via a connecting arm.

19. The computing device of claim 18, wherein the controller is to cause the motor to rotate the connecting arm.

20. The computing device of claim 19, wherein rotation of the connecting arm causes the directional radiation control device to rotate from the first position to the second position.
